(19) United States
(12) Patent Application Publication
(10) Pub. No.: US 2010/0075425 A1
(43) Pub. Date: Mar. 25, 2010

(54) MODULAR LABORATORY APPARATUS FOR ANALYSIS AND SYNTHESIS OF LIQUIDS AND METHOD FOR ANALYSIS AND SYNTHESIS OF LIQUIDS

(75) Inventors: Peter Hofmann, Grafenau (DE); Michael Winkler, Weissbach (DE)

Correspondence Address: CARLSON, GASKEY & OLDS, P.C., 400 WEST MAPLE ROAD, SUITE 350, BIRMINGHAM, MI, 48009, US

(73) Assignee: BURKERT WERKE GMBH & CO. KG, Ingelfingen (DE)

(21) Appl. No.: 12/447,720

(22) PCT Filed: Oct. 31, 2007
(86) PCT No.: PCT/EP2007/009444

§ 371 Date: Apr. 29, 2009

(30) Foreign Application Priority Data
Oct. 31, 2006 (DE) 10 2006 051 346.0

(51) Int. Cl. G01N 35/00; B01L 7/00

(52) U.S. Cl. 436/43; 422/68.1

(57) ABSTRACT

A modular laboratory apparatus for analysis and synthesis of liquids has a liquid tank, a central electronic evaluation unit, a multitude of functional modules, and a multitude of fluid modules. The functional modules and the fluid modules are mechanically connected in rows and are selectively connected to each other electrically and fluidically. At least one fluid module is fluidically connected to the liquid tank, and provision is made for electrical connections which connect the functional modules and the fluid modules to the central electronic evaluation unit. In a method for analysis and synthesis of liquids using a modular laboratory apparatus, the functional modules and the fluid modules are controlled by the central electronic evaluation unit by executing an analysis and/or synthesis program in order to perform an analysis procedure and/or a synthesis procedure.

### RELATED APPLICATION

This application is the U.S. national phase of PCT/EP2007/009444, filed 31 Oct. 2007, which claimed priority to DE patent application 10 2006 051 346.0, filed 31 Oct. 2006.

### FIELD OF THE INVENTION

The invention relates to a modular laboratory apparatus for analysis and synthesis of liquids and a method for analysis and synthesis of liquids.

### BACKGROUND OF THE INVENTION

Analysis and synthesis of liquids is effected in laboratories and is carried out in numerous individual process steps to determine all relevant physical and chemical properties, for example. Examples of the physical properties include turbidity, color, particle size. Examples of the chemical properties are ingredients such as metals, in particular calcium and magnesium (water hardness), nitrogen and phosphorus (fertilizer residues), chlorine and sodium. Concerning drinking water, a large variety of different contaminations are of significance, in particular biological content such as bacteria or industrial toxic substances. The regulations that are applicable here are established by government authorities or international organizations, such as the World Health Organization (WHO). Checks for compliance with these regulations require the existence of well-equipped laboratories and trained staff as well as considerable expenditure in terms of material and human resources.

### SUMMARY OF THE INVENTION

There is therefore a considerable need for a compact liquid analyzing and liquid synthesizing system which carries out a multiplicity of process steps in an automated manner and can be flexibly designed for the respective requirements.

The present invention provides such a laboratory system.

According to one example, the modular laboratory apparatus includes a liquid tank, a central electronic evaluation unit, a multitude of functional modules, and a multitude of fluid modules. The functional modules are arranged in rows and are mechanically connected to each other. The functional modules and the fluid modules are selectively connected with each other and with the liquid tank. Provision is made for electrical connections which selectively connect the functional modules and the fluid modules with each other and with the central electronic evaluation unit. Since the modular laboratory apparatus comprises a multitude of functional modules and fluid modules which, depending on the desired function, can be fitted in line and connected to each other mechanically and fluidically, the modular laboratory system may be flexibly adjusted to existing requirements in a simple and cost-effective way and may be expanded with a view to future requirements. Numerous analysis and/or synthesis steps may be carried out in parallel in one apparatus, as a result of which the duration of the process is shortened.

The present invention further provides a method for analysis and synthesis of liquids, this method distinguishing itself by its reliability, flexibility and low process costs.

According to one example method, the functional modules and the fluid modules are controlled by the central electronic evaluation unit by running an analysis program and/or a synthesis program in order to carry out analysis and/or synthesis procedures. Since the individual modules are connected to the central electronic evaluation unit by electrical connections, it is possible to centrally control analysis and synthesis procedures, to register and evaluate sensor signals of the functional modules, and to evaluate and assess measured results and analysis and synthesis results. With the analysis and/or synthesis running and progressing automatically, previous processes that were conventionally carried out manually in many individual steps can now be automated and standardized, which, for one thing, increases the reliability of the process and, for another, reduces process costs. Continuous monitoring is also possible.

These and other features of the present invention can be best understood from the following specification and drawings, the following of which is a brief description.

### BRIEF DESCRIPTION OF THE DRAWINGS

Further features and configurations of the invention will be apparent from the dependent claims and from the description of the preferred exemplary embodiment as shown in the Figures, in which:

FIG. 1 schematically shows a side view of an exemplary embodiment of the modular laboratory system according to the invention;

FIG. 2 schematically shows an exploded view of the modular laboratory system of FIG. 1; and

FIG. 3 shows a modular subunit of the modular laboratory system shown in FIGS. 1 and 2.

### DETAILED DESCRIPTION OF THE PREFERRED EMBODIMENT

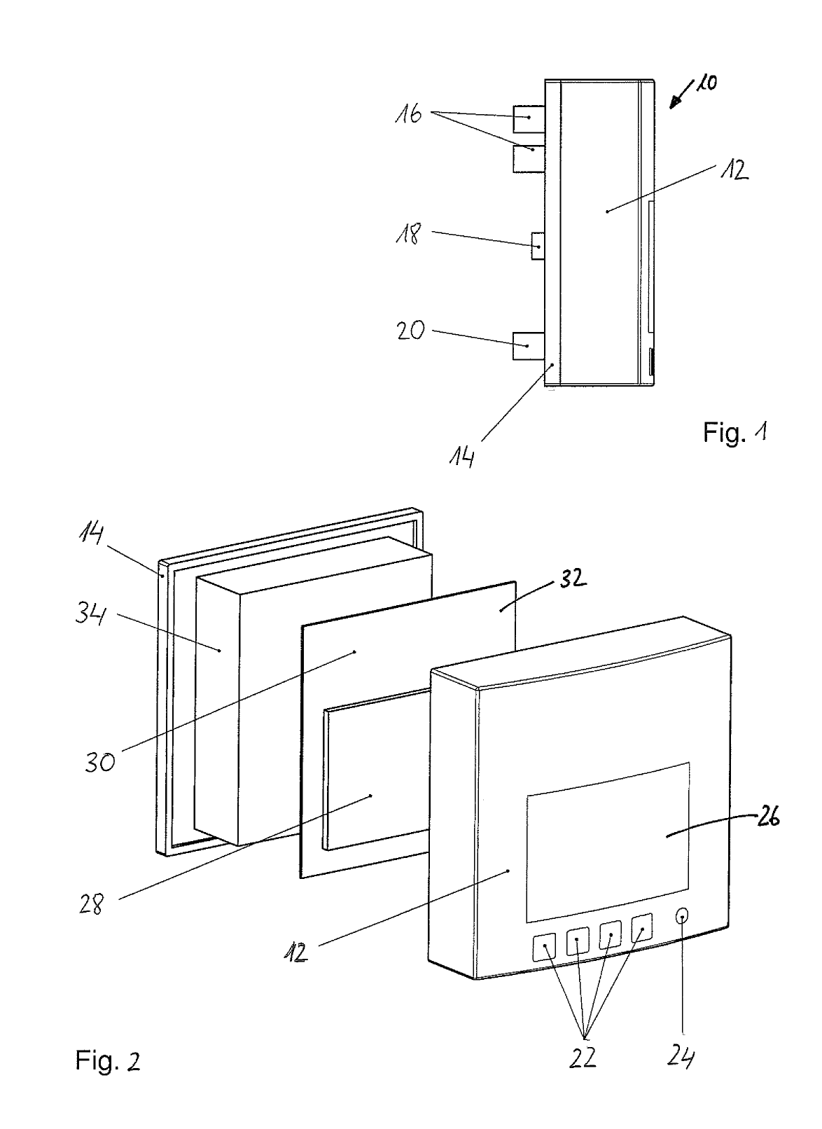

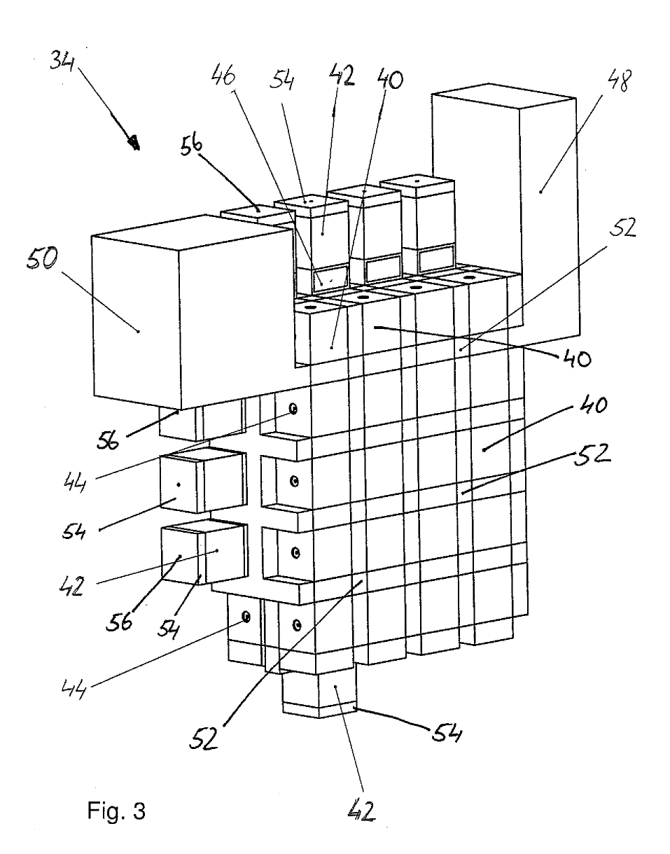

The modular laboratory system shown in FIG. 1 includes a housing 10 having an upper housing part 12 and a lower housing part 14. Provided on the lower housing part 14 are a plurality of fluidic connections 16 to the environment, an external connection 18 for a power supply 48 (shown in FIG. 3), and an electrical connection 20 to the environment. As shown in FIG. 2, a plurality of operating elements 22 and a communication interface 24 are provided on the upper housing part 12. The upper housing part 12 further has a recess 26 formed therein for a display unit 28. The display unit 28 is part of a central electronic evaluation unit 30 which constitutes a modular subunit 32 of the modular laboratory system. A further modular subunit 34 accommodated in the housing 10 is illustrated in greater detail in FIG. 3. The modular subunit 34 has a multitude of functional modules 40 and a multitude of fluid modules 42. The fluid modules 42 and the functional modules 40 are connected among and with each other by of standardized mechanical connections (not illustrated here). The fluid modules 42 and the functional modules 40 further include standardized electrical and fluidic connections 44 for connecting them to each other fluidically and electrically. The fluid modules 42 further comprise pump and/or valve elements 46.

While in the exemplary embodiment shown here the pump and/or valve elements 46 are components of the fluid modules 42, they may also be provided in separate control modules. The control modules are then, for their part, adapted to be connected electrically, mechanically and fluidically to the fluid modules 42 and to the functional modules 40 by standardized connections.

The modular subunit 34 shown in FIG. 3 further comprises a power supply 48 and a liquid tank 50. The functional modules 40 are arranged in a plurality of levels. The individual levels of the modular subunit 34 are connected to each other and to the central electronic evaluation unit 30 by electrical connections 52. At least some of the fluid modules 42 are fluidically connected to the liquid tank 50. The fluid modules 42 further include covers 54 on the side facing away from the functional modules 40, the covers 54 being provided with fluidic connections 56 that may be used for aerating or deaerating the fluid modules 42 or for filling in sample liquid or reagents and liquids required for analyses or syntheses. The fluidic connections 56 are each connected with one of the fluidic connections 16 to the environment that are formed on the lower housing part 14.

The functional modules 40 may comprise sensors for carrying out the desired measurements. For example, the functional modules 40 may contain sensors for measurement of pH, of conductivity, of turbidity, of the concentration of organic and inorganic ingredients. It is also possible to use a functional module 40 for mixing therein the sample liquid from the liquid tank 50 and/or the fluid modules 42 with another liquid such as, e.g., a tracer fluid or a second liquid for synthesis of a third liquid. The liquid with which the sample liquid is mixed may be conveyed from another fluid module 42 into the functional module 40 in question directly or via a further functional module 40. In addition, a functional module 40 may also comprise a reservoir for keeping a supply of the liquid required for the synthesis or analysis.

For analyzing or synthesizing a liquid, the liquid to be examined, or the liquid required for synthesis, is filled into the liquid tank 50. This may be done by using one of the fluidic connections 16 to the environment that are formed on the lower housing part 14. Partial samples may be distributed from the liquid tank 50 into fluid modules 42 by the pump and valve elements 46. Concentrations of different ingredients (nitrate, heavy metals, chlorine, etc.) may then be determined in parallel in each of these partial samples, for example. But it is also possible to carry out a defined analysis or synthesis sequence serially. The individual fluid modules 42 are fluidically and electrically linked to selected functional modules 40 via the standardized connections 44. To determine the concentration values, the liquid of the individual fluid modules 42 is distributed to the respective functional modules 40. The desired measurement may then take place in the functional modules 40. The functional modules 40 may, however, also be used for mixing the liquid with a further liquid. This mixture may then be transferred to a further functional module 40 for measurement purposes. Other possible functions of a functional module include demixing, metering, storage, filtering, separation and precipitation, for example.

For a continuous monitoring, the liquid tank 50 may be filled with liquid in defined time intervals or continuously.

The functional modules 40 and the fluid modules 42 are controlled by the central electronic evaluation unit 30 by an analysis and/or synthesis program to automatically carry out analysis and/or synthesis procedures. The central electronic evaluation unit 30 may trigger a warning or alert message if and when specific properties of the liquid determined in the analysis and/or synthesis exceed or fall short of predetermined values. The individual modules are driven by the central electronic evaluation unit 30 via the electrical connection 52, and sensor signals are transferred to the central electronic evaluation unit. In the central electronic evaluation unit, the sensor signals and all of the measured results and the analysis and/or synthesis results are registered, evaluated and assessed. Those functional modules 40 having sensors preferably comprise an electronic unit of their own for measuring signal conditioning. The pump and valve elements 46 are preferably adapted to be driven both manually and electronically by the central electronic evaluation unit 30 by a defined program so that any desired paths through the network formed of functional modules and fluid modules may be programmed and activated.

The modular laboratory system according to the invention is suitable for application as a tabletop unit and may also be used for measurements in the open when a battery is used for supplying power, for example.

Since the functional modules 40, the fluid modules 42 and, if applicable, the control modules may be fitted to each other in line and expanded as desired, depending on the desired requirements, the modular laboratory system according to the invention provides high flexibility and may be adjusted to new requirements in a simple and cost-effective manner. Owing to the central electronic evaluation unit, in which all measured results and analysis and synthesis results are centrally registered, evaluated and assessed, a cost-effective and time-saving method is provided. Since the results are stored, they may also be retrieved and traced at a later point in time. With the analysis and/or synthesis running and progressing automatically, previous processes that were carried out manually in many individual steps can be automated and standardized, which, for one thing, increases the reliability of the process and, for another thing, reduces process costs as well. Continuous monitoring is also possible.

Although an embodiment of this invention has been disclosed, a worker of ordinary skill in this art would recognize that certain modifications would come within the scope of this invention. For that reason, the following claims should be studied to determine the true scope and content of this invention.

1. A modular laboratory apparatus for analysis and synthesis of liquids, comprising:
a liquid tank,
a central electronic evaluation unit,
a multitude of functional modules, and
a multitude of fluid modules,
wherein
the multitude of functional modules and the multitude of fluid modules are mechanically connected in rows,
selected ones of the multitude of functional modules and of the multitude fluid modules are fluidically connected to each other,
the liquid tank is selectively connected with at least one of the multitude of fluid modules and the multitude of functional modules, and
selected ones of the multitude of functional modules and the multitude of fluid modules are electrically connected to the central electronic evaluation unit and with each other.

2. The modular laboratory apparatus according to claim 1, wherein the multitude of functional modules and the multitude fluid modules are arranged in a plurality of different levels.

3. The modular laboratory apparatus according to claim 2, wherein selected ones of the multitude of functional modules and the multitude of fluid modules of different levels are connected to each other.

4.-16. (canceled)

17. The modular laboratory apparatus according to claim 33, wherein the central electronic evaluation unit constitutes a second modular subunit.

18.-20. (canceled)

21. The modular laboratory apparatus according to claim 17, further including a common housing accommodating the first and second modular subunits.

22. (canceled)

23. The method according to claim 34, further comprising the steps of filling a sample liquid into a liquid tank and apportioning the multitude of functional modules with partial quantities of the sample liquid by at least one of the multitude of fluid modules.

24.-26. (canceled)

27. The modular laboratory apparatus according to claim 1, wherein the multitude of functional modules and the multitude of fluid modules each have a cuboid shape.

28. The modular laboratory apparatus according to claim 1, wherein the multitude of functional modules and the multitude of fluid modules have standardized connections on laterally adjacent faces.

29. The modular laboratory apparatus according to claim 1, wherein the multitude of fluid modules comprise at least one of microvalves and micropumps.

30. The modular laboratory apparatus according to claim 29, wherein the microvalves and micropumps are adapted to be driven manually.

31. The modular laboratory apparatus according to claim 29, wherein the microvalves and micropumps are adapted to be driven electrically under control of the central electronic evaluation unit.

32. The modular laboratory apparatus according to claim 1, wherein selected ones of the multitude of functional modules comprise a liquid reservoir.

33. The modular laboratory apparatus according to claim 1, wherein the multitude of fluid modules, the multitude of functional modules, the liquid tank, and a power supply constitute a first modular subunit.

34. A method for analysis and synthesis of liquids using a modular laboratory apparatus, comprising the step of:
controlling a multitude of functional modules and a multitude of fluid modules by having a central electronic evaluation unit execute an analysis and/or synthesis program to perform at least one of an analysis procedure and a synthesis procedure.

35. The method according to claim 34, wherein the program is executed continuously and is continuously monitored by the central electronic evaluation unit.
